(19) United States
(12) Patent Application Publication
(10) Pub. No.: US 2025/0371848 A1
(43) Pub. Date: Dec. 4, 2025

(54) SYSTEMS AND METHODS FOR GENERATING SYNTHETIC EDGE CASE DATA FOR COMPUTER VISION MODELS

(71) Applicant: NOBLIS, INC., Reston, VA (US)

(72) Inventors: Haley TOWNSEND, Galloway, OH (US); Sammy FELLAH, Leesburg, VA (US); Anand SESHADRI, Falls Church, VA (US)

(73) Assignee: NOBLIS, INC., Reston, VA (US)

(21) Appl. No.: 18/680,406

(22) Filed: May 31, 2024

(51) Int. Cl. G06V 10/774; G06F 40/40; G06T 11/00; G06V 10/776; G06V 20/54

(52) U.S. Cl. CPC G06V 10/774; G06F 40/40; G06T 11/00; G06V 10/776; G06V 20/54; G06V 2201/08

(57) ABSTRACT

A method for generating training data for a computer vision model can comprise providing an AI language model with first prompt data indicating visual scenarios to be evaluated by the computer vision model, generating, using the AI language model, based on the first prompt data and a prompting policy, second prompt data configured to cause an AI text-to-image model to generate images associated with the visual scenarios, generating the images using the second prompt data and the AI text-to-image model, applying the computer vision model to each image to generate, for each of the images, respective object detection data, and generating, for each image, performance data characterizing an effectiveness of the computer vision model, updating the prompting policy based on the performance data, and generating updated second prompt data based on the updated prompting policy.

### FIELD

The present disclosure relates generally to techniques for training artificial intelligence (AI) models, in particular to techniques for generating training data for improving the performance of computer vision models.

### BACKGROUND

Autonomous roadway safety systems such as intersection safety systems mounted near signalized intersections can visually monitor their surrounding area, perceive and detect potentially unsafe situations (e.g., a potential conflict between a pedestrian on a crosswalk and a speeding vehicle), and generate warning signals to warn roadway users of the hazard and/or directly control signal timing or other infrastructure to help mitigate the hazard. These systems can use artificial intelligence (AI) models (e.g., computer vision models) to interpret data collected by a variety of sensors and make informed decisions about their determinations, warning signals generated, and control signals generated.

AI-based perception does not perform in the same way as human perception, and in many cases lacks the situational awareness, historic knowledge, and common sense that would allow a human being to perceive and process a complex or novel visual scenario. In some embodiments, unpredictable and even minor aberrations (e.g., a pedestrian in a video frame partially obscured by a package they are carrying) can lead to major perception failures by AI vision systems, which may directly impact the safety of road users. Mitigating such perception failures requires training the AI models on “edge case” data representing examples of extremely rare visual scenarios depicting rare events (e.g., a wrong-way bus driving in foggy conditions) as well as novel or previously unseen scenarios and events (e.g., an autonomous delivery robot in a bike lane). However, due to the inherent infrequency of the types of events represented by edge case scenarios and events, edge case data are often difficult to acquire and, consequently, AI models receive little, if any, training for edge case scenarios.

### SUMMARY

As described above, improving performance of AI-based vision systems for traffic safety requires that the systems be able to accurately perceive and process rare and novel visual scenarios, including in “edge case” scenarios representing rare or novel conditions, rare or novel objects, rare or novel spatial arrangements, and rare or novel object behavior. However, due to their inherently rare or novel nature, edge case scenarios are not well-represented in training data sets that are used to train known AI vision systems. Because edge cases are inherently rare or even completely novel, there is a dearth of image data (and, in some cases, no known image data at all) representing edge case scenarios that can be used to train AI vision systems. Because of this issue, known AI vision systems that rely on image training data often perform poorly and erratically in edge case scenarios.

Accordingly, there is a need for improved systems and methods for generating synthetic training data representing edge case visual scenarios. In particular, there is a need for improved systems and methods for generating synthetic training data representing edge case visual scenarios for computer-vision-based autonomous roadway safety systems, including stationary computer-vision based roadway monitoring systems.

Disclosed herein are systems and methods that may address one or more of the above-identified needs. Specifically, provided is a machine-learning-based technique for generating edge case scenarios and corresponding image data for improving the performance of computer vision models such as those used in autonomous roadway safety systems. The technique leverages an AI-based large language model (LLM) or “AI language model” (e.g., GPT, Gemini, Llama, Mistral) to create prompts for an AI text-to-image model (e.g., DALL-E, Midjourney, Stable Diffusion, Leonardo AI) that cause the AI text-to-image model to generate synthetic edge case images representing a myriad of rare and novel visual scenarios that could potentially be encountered by a computer vision model. The AI language model allows the system to quickly generate a large number of similar but subtly and intentionally varied prompts for the AI text-to-image model, where each of the prompts for the AI text-to-image model describes a given edge case scenario in a slightly different way. The AI text-to-image model may then receive the prompts generated by the AI language model as input and, based on each of the prompts, may generate a multitude of images in response to a given prompt, wherein each generated image may represent the edge case scenario in a slightly different way. This combination of AI models may thus enable robust and efficient creation of edge case data sets, especially for scenarios for which real data (e.g., non-AI generated synthetic data) are unavailable, scare, or costly to collect.

As disclosed herein, the systems and methods may analyze generated edge-case image data. For example, analysis results may be used to assess and quantify how well a trained computer vision model (e.g., object detection model) performs in analyzing a generated synthetic edge-case image. If the computer vision model performs poorly (e.g., incorrectly identifies object types or object locations), then the system may determine that the synthetic edge-case images will be of value in training the computer vision model (or other computer vision models) to improve future performance, and the synthetic edge-case images for which performance by the computer vision model was poor may be added to a training data set. On the other hand, if the computer vision model performs well (e.g., correctly identifying object types or object locations), then the system may determine that the synthetic edge-case images will be of limited value in training the computer vision model (or other computer vision models) to improve future performance, since the model already performs adequately on those samples. Thus, in scenarios where the computer vision model performed well, the system may perform one or more iterations to iteratively enhance the text prompt that is fed into the text-to-image model to generate additional synthetic edge-case image data, and to determine whether that additional, subsequently-created edge-case image data is analyzed accurately or inaccurately by the computer vision model.

Scenarios wherein the computer vision model performs poorly can indicate where edge case data is required for future training of the computer vision model. The described techniques herein utilize a sophisticated iterative prompting process to streamline the production of edge case data and ensure that the weaknesses of the computer vision model are efficiently addressed. Based on input data indicating a particular edge case visual scenario to be evaluated by the computer vision model, the AI language model may generate prompt data for the text-to-image AI model to cause the text-to-image AI model to generate edge case images associated with the input data. The AI language model may generate the prompt data according to rules or information indicated in a prompting policy. The computer vision model may be applied to each generated edge case image and, for each, performance data characterizing the effectiveness of the computer vision model can be generated. This performance data can be used to update the prompting policy that governs the AI language model. For example, if the performance data indicate that the computer vision model is highly effective at interpreting a certain edge case image, the prompting policy can be updated to indicate that the computer vision model should generate edge-case images having a greater complexity.

In this way, the prompts that are used to prompt the text-to-image AI model may be adjusted iteratively to dial up or down the complexity of the generated synthetic edge-case images, thereby allowing the system to self-optimize for generation of edge-case images that will be most effective at providing future training data to the computer vision model or to other similar models. Iterative creation of new prompts may involve algorithmic generation of new prompts and/or algorithmic modification of preexisting prompts.

The system may be thought of as a type of genetic algorithm (or as similar to a genetic algorithm), in which a population of AI model prompts and prompting policies are evolved over successive iterations under the evolutionary pressures of a fitness function that assesses performance of the computer vision model in analyzing the generated images. In the disclosed systems, the genetic algorithm may evolutionarily select for synthetic edge-case images in which performance of the computer vision model is poor, thereby evolving a population of AI model prompts (and prompting policies) and resulting synthetic edge-case images that are resistant to accurate classification by the computer vision model but could be classified readily by a human annotator, and are thereby highly effective for use as training data in future training of the model to improve its accuracy and performance. Notably, these generated images may maintain realism.

The techniques disclosed herein therefore enable efficient and effective creation of novel synthetic edge-case image data, using multiple AI models arranged in an iterative process in the style of a genetic algorithm. This arrangement may allow for the creation of synthetic edge-case image data that is difficult for existing computer vision models to effectively and accurately process, therefore making the synthetic edge-case image data highly valuable for future training of computer vision models. By improving training of computer vision models, computer-vision-based autonomous roadway safety systems may be improved, allowing them to more effectively respond to rare and novel visual scenarios and thereby significantly reducing the likelihood of perception failures and collisions.

A method for generating training data for a computer vision model comprises providing an AI language model (e.g., a large language model) with first prompt data indicating one or more visual scenarios to be evaluated by the computer vision model. An iteration of image data generation and analysis can then be performed. The iteration of image data generation and analysis can comprise: generating, using the AI language model, based on the first prompt data and a prompting policy, second prompt data for an AI text-to-image model, wherein the second prompt data is configured to cause the AI text-to-image model to generate a plurality of images associated with the one or more visual scenarios; generating, using the AI text-to-image model, the plurality of images using the second prompt data; applying the computer vision model to each image of the plurality of generated synthetic images to generate, for each of the images, respective object detection data; and generating, for each image of the generated images, performance data characterizing an effectiveness of the computer vision model. Following the performance of the iteration of image data generation and analysis, the prompting policy can be updated based on the performance data. A second iteration of image data generation and analysis may then be performed. Performing the second iteration can include generating updated second prompt data based on the updated prompting policy. The computer vision model may be configured to be used in an autonomous roadway safety system.

The method can further comprise determining that the second iteration of image data generation and analysis should be performed. In some embodiments, determining that the second iteration of image data generation and analysis should be performed includes determining that the performance data indicate high effectiveness of the computer vision model for at least one image of the plurality of generated images. In these embodiments, updating prompting policy can comprise configuring the prompting policy such that the updated second prompt data generated by the AI language model causes the AI text-to-image model to generate an updated plurality of images having increased level of complexity relative to the at least one image of plurality of images generated by the AI text-to-image model during the first iteration of image data generation and analysis for which the computer vision model was highly effective. In other embodiments, determining that the second iteration of image data generation and analysis should be performed comprises determining that the performance data indicate low effectiveness of the computer vision model for at least one image of the plurality of synthesized images. In these embodiments, updating the prompting policy can comprise configuring the prompting policy such that the updated second prompt data generated by the AI language model causes the AI text-to-image model to synthesize an updated plurality of images having a similar level of complexity to the at least one image of the plurality of images synthesized by the AI text-to-image model during the second iteration of image data generation and analysis for which the computer vision model had low effectiveness.

The method can further comprise determining that a third iteration of image data generation and analysis should not be performed. Determining that a third iteration of image data generation and analysis should not be performed can include determining that the performance data indicate low effectiveness of the computer vision model for the plurality of generated images. The plurality of generated images for which the performance data indicated poor performance by the computer vision model can be stored in a database of training data for the computer vision model, and the computer vision model can be re-trained based on the plurality of generated images stored in the database of training data.

The object detection data for one or more images of the plurality of generated images can include one or more respective bounding boxes indicating one or more respective locations in the respective image of objects detected by the computer vision model, classification data indicating one or more object types detected in the respective image by the computer vision model, confidence score data indicating one or more confidence values associated with a respective object detected in the respective image by the computer vision model, or combinations thereof. In some embodiments, generating the performance data for an image of the plurality of generated images includes comparing object detection data for the image to corresponding ground truth data indicating objects that are actually present in the image. In some embodiments, generating the performance data for an image of the plurality of generated images includes computing a reward metric for the image, wherein the reward metric is configured to quantify a performance level of the computer vision model. A magnitude of the reward metric may be greater when the performance of the computer vision model for the image is lower. In some embodiments, generating the performance data for an image of the plurality of generated images includes determining whether the computer vision model accurately identified one or more critical objects in the image. The prompting policy can be updated using reinforcement learning.

A system for generating synthetic image training data for a computer vision model can comprise one or more processors configured to: provide an AI language model with first prompt data indicating one or more visual scenarios to be evaluated by the computer vision model; perform an iteration of image data generation and analysis, comprising: generate, using the AI language model, based on the first prompt data and a prompting policy, second prompt data for an AI text-to-image model, wherein the second prompt data is configured to cause the AI text-to-image model to generate a plurality of images associated with the one or more visual scenarios; generate, using the AI text-to-image model, the plurality of images using the second prompt data; apply the computer vision model to each image of the plurality of generated images to generate, for each of the images, respective object detection data; and generate, for each image of the synthesized images, performance data characterizing effectiveness of the computer vision model; update the prompting policy based on the performance data, and perform a second iteration of image data generation and analysis, wherein performing the second iteration comprises generating updated second prompt data based on the updated prompting policy.

A non-transitory computer readable storage medium storing instructions for generating training data for a computer vision model that, when executed by one or more processors of a computer system, may cause the system to: provide an AI language model with first prompt data indicating one or more visual scenarios to be evaluated by the computer vision model; perform an iteration of image data generation and analysis, comprising: generate, using the AI language model, based on the first prompt data and a prompting policy, second prompt data for an AI text-to-image model, wherein the second prompt data is configured to cause the AI text-to-image model to generate a plurality of images associated with the one or more visual scenarios; generate, using the AI text-to-image model, the plurality of images using the second prompt data; apply the computer vision model to each image of the plurality of generated images to generate, for each of the images, respective object detection data; and generate, for each image of the synthesized images, performance data characterizing effectiveness of the computer vision model; update the prompting policy based on the performance data, and perform a second iteration of image data generation and analysis, wherein performing the second iteration comprises generating updated second prompt data based on the updated prompting policy.

### BRIEF DESCRIPTION OF THE FIGURES

The patent or application file contains at least one drawing executed in color. Copies of this patent or patent application publication with color drawing(s) will be provided by the Office upon request and payment of the necessary fee.

The following figures depict various systems and methods for generating synthetic edge case training data for a computer vision model. The systems and methods shown in the figures may have any one or more of the characteristics described herein.

FIG. 1 shows a system for generating synthetic edge case training data for a computer vision model, according to some embodiments.

FIG. 2 shows a computer system, according to some embodiments.

FIG. 3 shows a method for generating synthetic edge case training data for a computer vision model, according to some embodiments.

FIG. 4 shows example synthetic edge case images generated using the provided systems and methods.

FIG. 5A shows output from an example computer vision model applied to an example edge case image.

FIG. 5B shows output from an example computer vision model's detections compared to the ground truth for the example edge case image shown in FIG. 5A.

FIG. 5C shows an overlay of bounding boxes from the computer vision model (in black) and ground truth bounding boxes (in white) for the example edge case image shown in FIGS. 5A-5B.

### DETAILED DESCRIPTION

Described are systems, methods, and non-transitory computer readable storage media for generating edge case data to improve the performance of computer vision models such as those used in autonomous roadway safety systems. The systems, methods, and non-transitory computer readable storage media leverage an AI language model (e.g., GPT, Gemini, Llama, Mistral) to create prompts for an AI text-to-image model (e.g., DALL-E, Midjourney, Stable Diffusion, Leonardo AI) that cause the AI text-to-image model to generate edge case images representing a myriad of rare and novel visual scenarios that could potentially be encountered by a computer vision model. Employing the AI language model, which can quickly generate a large number of prompts describing a given edge case scenario, in combination with the AI text-to-image model, which can efficiently produce a multitude of images in response to a given prompt, enables robust edge case data sets to be generated even for scenarios where real (e.g., non-AI generated) data are scarce or unavailable. The disclosed systems, methods, and non-transitory computer readable storage media therefore enable computer vision models to effectively respond to aberrations and significantly reduce the likelihood of perception failures.

The systems, methods, and non-transitory computer readable storage media disclosed herein can analyze generated edge-case image data, for example to assess and quantify how well a trained computer vision model (e.g., object detection model) performs in analyzing a generated synthetic edge-case image. Scenarios wherein the computer vision model performs poorly can indicate where edge case data is required for future training of the computer vision model. The described techniques herein utilize a sophisticated iterative prompting process to streamline the production of edge case data and ensure that the weaknesses of the computer vision model are efficiently addressed. Based on input data indicating a particular edge case visual scenario to be evaluated by the computer vision model, the AI language model may generate prompt data for the text-to-image AI model to cause the text-to-image AI model to generate edge case images associated with the input data. The AI language model may generate the prompt data according to rules or information indicated in a prompting policy. The computer vision model may be applied to each generated synthetic edge case image and, for each, performance data characterizing the effectiveness of the computer vision model can be generated. This performance data can be used to update the prompting policy that governs the AI language model. For example, if the performance data indicate that the computer vision model is highly effective at interpreting a certain edge case image, the prompting policy can be updated to indicate that the computer vision model should generate edge-case images having a greater complexity.

In this way, the prompts that are used to prompt the text-to-image AI model may be adjusted iteratively to dial up or down the complexity of the generated synthetic edge-case images, thereby allowing the system to self-optimize for generation of edge-case images that will be most effective at providing future training data to the computer vision model or to other similar models. Iterative creation of new prompts may involve algorithmic generation of new prompts and/or algorithmic modification of preexisting prompts.

The techniques disclosed herein therefore enable efficient and effective creation of novel synthetic edge-case image data, using multiple AI models arranged in an iterative process in the style of a genetic algorithm. This arrangement may allow for the creation of synthetic edge-case image data that are difficult for existing computer vision models to effectively and accurately process, therefore making the synthetic edge-case image data highly valuable for future training of computer vision models. By improving training of computer vision models, computer-vision-based autonomous roadway safety systems may be improved, allowing them to more effectively respond to rare and novel visual scenarios and thereby significantly reducing the likelihood of perception failures and collisions.

### System for Generating Synthetic Edge Case Training Data

The provided system for generating synthetic edge case training data for a computer vision model can comprise a combination of generative AI models. These AI models may include an AI language model (e.g., a large language model (LLM)) for creating descriptions of edge case scenarios and an AI text-to-image model for generating synthetic edge case image data. The system may use a reinforcement learning approach based on the computer vision model's performance on the generated edge case image data to create increasingly difficult and specific prompts that are used to generate realistic and useful synthetic edge-case images containing conditions, objects, behaviors, or other features that are difficult to detect and classify correctly using existing computer vision models and therefore are valuable for future training of computer vision models. (As noted above, the disclosed iterative approach of generating increasingly complex and specific prompts under selection pressure to generate images that are poorly-interpreted or ineffectively-processed by a computer vision model, may be understood as a kind of genetic algorithm system.) For a computer vision model used in an autonomous agent on public roads, such as an autonomous vehicle or an infrastructure-based autonomous roadway safety system, the disclosed system can enable transportation agencies to comprehensively and cost-effectively test the model in safety-critical situations, generate synthetic training data for efficiently and effectively further training the model, and further train the model using said synthetic training data to improve model performance and improve driver and pedestrian safety.

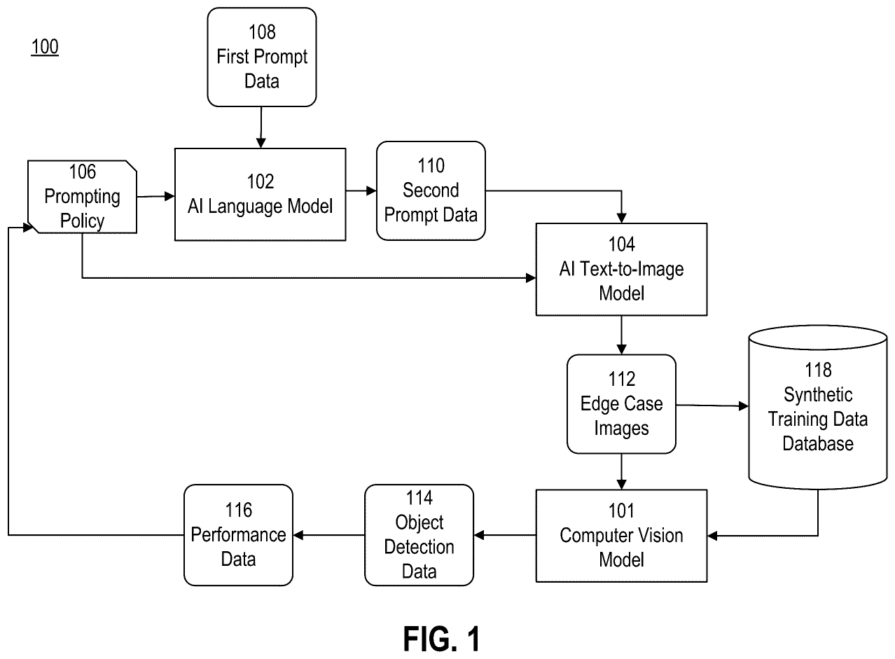

FIG. 1 shows a schematic representation of a system 100 and associated process for generating edge case image data for training a computer vision model 101. Computer vision model 101 can be a component of an autonomous agent, such as an autonomous roadway safety system. For instance, computer vision model 101 may be a component of an intersection safety system configured to be mounted near a signalized intersection to monitor the area around the intersection and warn roadway users of potentially unsafe situations, such as a potential conflict between a pedestrian and a speeding vehicle. Examples of such computer vision models include (but are not limited to) OpenCV-developed models such as You Only Look Once (YOLO), Single Shot MulitBox Detector (SSD), MobileNet-SSD, and Faster R-CNN, or deep learning architectures such as Vision Transformer (ViT), ResNet, and RetinaNet.

The system for generating edge case image training data for computer vision model 101 can include an AI language model 102 and an AI text-to-image model 104. AI language model 102 can be any suitable AI model for generating text outputs, for example a large language model (LLM) such as OpenAI's GPT, Google's LaMDA, PaLM, or Gemini, or Meta's LLaMA. Likewise, AI text-to-image model 104 can be any suitable AI model for generating image outputs from text inputs, for instance OpenAI's DALL-E, Google's Imagen, StabilityAI's Stable Diffusion, Midjourney, or LeonardoAI.

First prompt data 108 can be provided as input (e.g., an input text string typed by a user) to AI language model 102. AI language model 102 can be given a “system” role to optimize a simple text prompt inputted using a command line interface (CLI) or graphical user interface (GUI). AI language model 102 can be instructed to add details related to safety-critical aspects, such as adverse weather conditions, busy roadways, or occlusions, in a single sentence that optimizes first prompt data 108. Additionally, the specific text-to-image model can be detailed in the prompt to AI language model 102 to generate specific prompts catered to AI text-to-image model 104. First prompt data 108 may indicate one or more edge case visual scenarios to be evaluated by computer vision model 101. In some embodiments, first prompt data 108 is generated empirically. For example, first prompt data 108 may be generated by analyzing visual scenarios that are well-represented in the training data for the computer vision model and then generating data indicating visual scenarios that are not well-represented in the training data. First prompt data 108 may describe scenarios in which computer vision model 101 has a high probability of performing poorly based on, e.g., the historical performance of computer vision model 101 (or similar computer vision models) and/or the training data upon which computer vision model 101 has already been trained.

Based on first prompt data 108, AI language model 102 can generate second prompt data 110. Second prompt data 110 may include text data (e.g., natural language data) describing the one or more edge case visual scenarios to be evaluated by computer vision model 101. In some embodiments, system 100 may be configured such that AI language model 102 generates, as part of second prompt data 110, multiple text strings based on a single text string of first prompt data 108. Any one or more of the generated strings in second prompt data may (or may not) be carried forward throughout the process shown in FIG. 1, for example according to one or more system policies or rules, and/or according to one or more user inputs or preferences. For the non-limiting purposes of the exemplary description herein, the description may contemplate and describe a single text string in second prompt data 110.

The generation of second prompt data 110 by AI language model 102 may be governed by a prompting policy 106. Prompting policy 106 can include rules and/or an algorithm for prompting AI language model 102 to generate second prompt data 110. Prompting policy 106 can be implemented and used to manipulate the input to the AI text-to-image model 104 through a human-in-the-loop mechanism where a user can provide suggestions to the AI Language model that can be carried forward in future iterations. Additionally or alternatively, prompting policy 106 can include pre-determined prompts that can be provided as input to the AI text-to-image model 104 using an API call similar to that which can be used to generate the initial prompt. Additionally or alternatively, the prompting policy 106 may follow an algorithmic approach, such as a reinforcement learning (RL) approach, where the policy and value function are updated based on performance data 116. For example, the policy can be deterministic or stochastic and can utilize policy gradient or actor-critic methods to improve upon previous iterations. Policy gradient methods adjust the parameters of the policy using a gradient ascent approach to increase expected outcomes, while actor-critic methods combine a value function with the prompting policy to create refined outcomes and results. Temporal Difference (TD) learning and Monte Carlo (MC) methods are two example approaches used in RL to estimate value functions and optimize policies that could be used here. Additionally, prompting policy 106 can implement strategies to balance new, novel outcomes and outcomes more closely tied to known iterations that have shown to be successful in generation.

Prompting policy 106 may be a comparator and/or decision point that generates output that contains text that can be used to modify the system role of AI language model 102 or can be sample prompts pre-defined based on the performance data 116. In some embodiments, prompting policy 106 is not accessed directly by the language model but is used to generate text passed through the API call. The output of prompting policy 106 can be stored as a variable string to be inputted into the system role parameter of the API call. AI language model 102 may not directly interface with prompting policy 106; rather, through the output text which is provided as input through the API, AI language model 102 may be given a system role along with a user input. Prompting policy 106 can be closely tied to the system role in order for the AI language model 102 to be able to generate images based on the effectiveness of its previous iterations. For example, the system role can be a way of implementing a decision of prompting policy 106 by giving AI language model 102 an enhanced or modified role based on the performance data and analysis.

In some embodiments, prompting policy 106 may indicate how first prompt data 108 should be provided to AI language model 102 as well as information configured to control the output of AI language model 102. For example, prompting policy 106 can be configured to cause AI language model to generate second prompt data 102 that includes multiple different descriptions of a given edge case visual scenario (e.g., multiple descriptions of the same weather condition, as shown in Table 1) or descriptions of multiple different variations of a given edge case visual scenario (e.g., multiple descriptions of different weather conditions that create similar visual scenarios, as shown in Table 2).

TABLE 1
Example outputs from an AI language model providing
different descriptions of a visual scenario containing
the same foundational elements.

| | | |
|---|---|---|
| First Prompt | Output 1 | An intersection in a city on a rainy day. |
| Data: | Output 2 | A city intersection in rainy weather. |
| “intersection” | Output 3 | A signalized intersection between city |
| AND “rain” AND | | roads during a rainstorm. |
| “city” | | |

TABLE 2
Example outputs from an AI language model providing descriptions
of the multiple variations of a visual scenario.

| | | |
|---|---|---|
| First Prompt | Output 1 | An intersection in a city in light rain. |
| Data: | Output 2 | An intersection in a city in a heavy |
| “intersection” | | rainstorm. |
| AND “rain” AND | Output 3 | An intersection in a city in rain and fog. |
| “city” | | |

In some embodiments, prompting policy 106 may indicate a number of output strings that should be generated as part of second prompt data 110. For example, a number of different output strings per input string may be indicated.

In some embodiments, prompting policy 106 may indicate a length or length range for one or more strings generated as part of second prompt data 110.

In some embodiments, prompting policy 106 may indicate one or more languages for one or more strings generated as part of second prompt data 110.

In some embodiments, prompting policy 106 may indicate one or more levels of complexity for one or more strings generated as part of second prompt data 110. For example, prompting policy 106 may include rules or indications regarding complexity of language for text strings included in second prompt data 110 itself, and/or may include an indication regarding a level of complexity that should be indicated by text strings in second prompt data 110. For example, a rule regarding complexity of language for text strings included in second prompt data 110 may specify grammatical structure, vocabulary level, reading level, word complexity, string length, number of clauses, or other information. Additionally or alternatively, a rule regarding complexity that should be indicated by text strings in second prompt data 110 may include a rule that the generated text string should describe a complex scene, include occluded or obscured objects, include motion artifacts, include a large number of objects, and/or depict difficult perception scenarios, such as poor visibility. A rule regarding complexity that should be indicated by text strings in second prompt data 110 may include a level of complexity to be indicated, for example by specifying “moderately” poor visibility, “significantly” poor visibility, “extremely” poor visibility, or other descriptors.

In some embodiments, prompting policy 106 may specify, for situations in which a plurality of different text strings is to be generated for second prompt data 110, a level of variation that should be present amongst the different text strings generated. Prompting policy 106 may specify a quantification of similarity, a quantification of difference, and/or characteristics of a distribution across different text strings, wherein the similarities, differences, or distributions may be with respect to any quantifiable attribute of the text strings (e.g., length, complexity).

In some embodiments, prompting policy 106 may be configured to be provided to AI language model 102 by being appended to or otherwise provided in conjunction with first prompt 108 for processing by AI language model 102. In some embodiments, prompting policy 106 may be configured to be provided to AI language model 102 as a “custom instruction” for AI language model 102.

In some embodiments, prompting policy 106 may be driven by a deterministic or stochastic RL policy that is optimized after numerous iterations based on an optimization algorithm, such as Proximal Policy Optimization (PPO) which aims to balance exploration, stability, and efficiency. As prompting policy 106 is optimized, first prompt data 108 may be iteratively improved. For example, if first prompt data 108 initially comprises “A car driving has trouble seeing people,” first prompt data 108 may be updated as follows as prompting policy 106 is optimized:
Update 1: “A car driving at night has trouble seeing people.”
Update 2: “A car driving late at night has trouble seeing people.”
Update 3: “A car driving late at night in the snow has trouble seeing people.”
Update 4: “A car driving late at night in the snow has trouble seeing pedestrians.”

After second prompt data 110 is generated by AI language model 102, text strings from second prompt data 110 may be provided as input to AI text-to-image model 104. Second prompt data 110 may cause AI text-to-image model 104 to generate a plurality of edge case images 112 associated with the one or more edge case visual scenarios contained in the prompt.

In some embodiments, system 100 may be configured such that AI text-to-image model 104 generates multiple images 112 based on a single text string of second prompt data 110. Any one or more of the generated images 112 may (or may not) be carried forward throughout the process shown in FIG. 1, for example according to one or more system policies or rules (e.g., quality assurance modules), and/or according to one or more user inputs or preferences. For the non-limiting purposes of the exemplary description herein, the description may contemplate and describe a single image 112 per input text string in second prompt data 110.

Creation of the synthetic edge-case images 112 may in some embodiments be governed by prompting policy 106. In some embodiments, prompting policy 106 may indicate a number of images 112 that should be generated. For example, a number of different images 112 per input text string may be indicated. In some embodiments, prompting policy 106 may indicate one or more dimensions or dimension ranges for one or more images 112. In some embodiments, prompting policy 106 may indicate one or more image formats for one or more images 110. In some embodiments, prompting policy 106 may indicate one or more measurable and/or simulated image attributes (e.g., brightness levels, saturation levels, exposure time, blur, color levels) for one or more images 110.

In some embodiments, prompting policy 106 may specify, for situations in which a plurality of different images 112 are to be generated for a single input string, a level of variation that should be present amongst the different images 112 generated. Prompting policy 106 may specify a quantification of similarity, a quantification of difference, and/or characteristics of a distribution across different images 112, wherein the similarities, differences, or distributions may be with respect to any quantifiable attribute of the images 112 (e.g., dimensions, brightness, saturation, level of realism).

The generated edge-case images 112 may, as described below, be used in an iterative feedback loop in which they are analyzed by computer vision model 101, and the analysis results (and optionally the images 112 themselves) are used to iterate the process depicted in FIG. 1 to create additional synthetic images using modified prompting policies and/or modified prompts. Additionally or alternatively, if one or more criteria are met, edge case images 112 may be stored as part of synthetic training data database 118, and may thereafter be used to re-train and update computer vision model 101 and/or to train additional computer vision models.

A pre-trained version of computer vision model 101 can be applied to each edge case image of the plurality of edge case images 112 synthesized by AI text-to-image model 104. For each edge case image, computer vision model 101 may generate object detection data 114 indicating the objects detected by computer vision model 101 in the image. Object detection data 114 can include bounding boxes that identify the locations of objects in the edge case image, classification data indicating the type or class of each detected object, confidence scores indicating a probability that a detected object is actually present in bounding box in the edge case image, or combinations thereof.

Based on object detection data 114, performance data 116 characterizing the effectiveness of computer vision model 101 as applied to an analyzed image can be generated for each edge respective case image of the plurality of edge case images 112. For example, as described below, performance data may be based at least in part on a comparison of bounding boxes and other object detection output data generated by model 101 against bounding boxes and other “ground truth” object detection output data generated by another manual or automated annotation technique. For example, as described below, a quantification such as an intersection-over-union (IoU) comparison of bounding boxes may be calculated. In some embodiments, performance data may include one or more performance adjustments applied based on a determination of whether one or more “safety critical” errors is made. For example, a performance score may be adjusted (e.g., by subtracting a value or by applying a multiplier adjustment) in cases where model 101 fails to identify a pedestrian or makes one or more other safety-critical errors.

System 100 may then analyze performance data 116 to determine whether one or more adjustments to prompting policy 106 (and/or to previously applied prompt data 110) should be applied. If performance data 116 indicates good performance (e.g., based on a value of a predefined or dynamically determined threshold score) of model 101 for at least one of edge case images 112, then it may be determined that said edge case image (and images similar to said edge case image) would not be of significant value in re-training model 101 or training other computer vision models. System 100 may therefore initiate a new iteration of the process depicted in FIG. 1 by updating prompting policy 106 to generate new second prompt data 110 and new edge case images 112, wherein the new edge case images 112 are of higher complexity than the at least one edge case image for which model 101 displayed good performance during the first iteration of the process and are thus more likely to be of value in training or re-training computer vision models such as model 101.

In some embodiments, updating prompting policy 106 may include modifying one or more parameters of prompting policy 106 to generate more complex second prompt data 110. In some embodiments, the iterative feedback loop depicted in FIG. 1 may include regenerating prompting policy 106 from scratch, modifying existing contents of prompting policy 106, regenerating second prompt data from scratch, and/or modifying existing contents of prompting policy 106. (Additionally or alternatively in some embodiments, the iterative feedback loop depicted in FIG. 1 may include regenerating edge case images 112 from scratch, or modifying existing contents and/or existing portions of edge case images 112.)

Updating prompting policy 106 to generate new edge case images 112 that are of higher complexity than edge case image(s) for which model 101 displayed good performance during the first iteration of the process can comprise configuring prompting policy 106 such that updated second prompt data 110 causes AI text-to-image model 104 to generate a plurality of images having increased level of complexity relative to the at least one image generated during the first iteration for which computer vision model 101 was highly effective. For example, prompting policy 106 can be updated such that second prompt data 110 causes AI text-to-image model 104 to generate images that, compared to an image generated during the first iteration for which computer vision model 101 was highly effective, show a greater number of objects, show a greater variety of objects, have different lighting, or show a greater number of obstructions that may prevent computer vision model 101 from identifying objects of importance.

If, on the other hand, performance data 116 indicates poor performance (e.g., based on a predefined or dynamically determined threshold score) of model 101, then it may be determined that the analyzed edge case images 112 would be of significant value in re-training model 101 or training other computer vision models, and system 100 may therefore store the edge case images 112 in synthetic training data database 118, such that they may be used to re-train model 101 or to train additional computer vision models for improved performance. In some embodiments, if performance data 116 indicates poor performance of model 101, the iterations of the process shown in FIG. 1 may cease.

In some embodiments, system 100 may be alternatively or additionally configured to iterate in order to generate more synthetic edge case images 112 that are similar to synthetic edge case images 112 that have already been established to lead to poor performance by model 101. For example, if performance data 116 indicates that computer vision model 101 cannot effectively interpret a certain visual scenario, prompting policy 106 can be updated to cause AI language model 102 to generate updated second prompt data 110 that contains a larger number of examples of that visual scenario. For example, if an edge case image depicts a city intersection on a rainy day, and computer vision model 101 fails to identify a pedestrian in the intersection, performance data 116 may indicate computer vision model 101's failure and prompting policy 106 may be updated to cause AI language model 102 to generate updated second prompt data 110 that contains additional examples of a city intersection on a rainy day. In this way, a larger body of training data depicting edge case scenarios that are difficult for model 101 (and therefore expected to be valuable in re-training model 101 or training other computer vision models) may be quickly and effectively generated.

Using performance results as feedback to improve prompting policy 106 may improve the prompt learning and corresponding image generation process and ensure steady and directed enhancement of the capabilities of computer vision model 101.

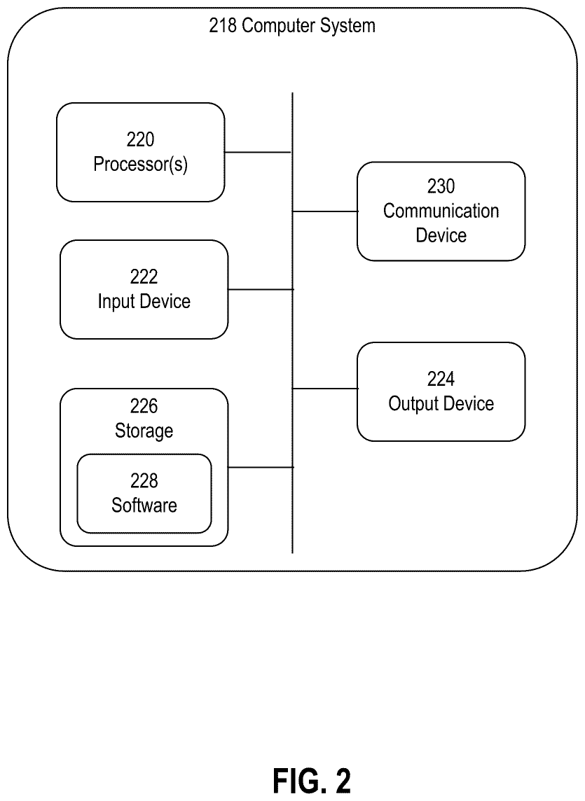

A system for synthesizing edge case data for training a computer vision model such as the system illustrated in FIG. 1 can be implemented using a computer system. FIG. 2 shows an exemplary computer system 218. Computer system 218 can be any suitable type of microprocessor-based device, such as a personal computer, workstation, server, or handheld computing device (portable electronic device) such as a phone or tablet, or dedicated device. As shown in FIG. 2, computer system 218 may include one or more classical (binary) processors 220, an input device 222, an output device 224, storage 226, and a communication device 230.

Input device 222 and output device 224 can be connectable or integrated with system 102. Input device 222 may be any suitable device that provides input, such as a touch screen, keyboard or keypad, mouse, or voice-recognition device. Likewise, output device 224 can be any suitable device that provides output, such as a display, touch screen, haptics device, or speaker.

Storage 226 can be any suitable device that provides storage, such as an electrical, magnetic, or optical memory, including a RAM, cache, hard drive, removable storage disk, or other non-transitory computer readable medium. Communication device 230 can include any suitable device capable of transmitting and receiving signals over a network, such as a network interface chip or device. The components of computer system 218 can be connected in any suitable manner, such as via a physical bus or via a wireless network.

Processor(s) 220 may be or comprise any suitable classical processor or combination of classical processors, including any of, or any combination of, a central processing unit (CPU), a field programmable gate array (FPGA), and an application-specific integrated circuit (ASIC). Software 228, which can be stored in storage 226 and executed by processor(s) 220, can include, for example, the programming that embodies the functionality of the present disclosure. Software 228 may be stored and/or transported within any non-transitory computer-readable storage medium for use by or in connection with an instruction execution system, apparatus, or device that can fetch instructions associated with the software from the instruction execution system, apparatus, or device and execute the instructions. In the context of this disclosure, a computer-readable storage medium can be any medium, such as storage 226, that can contain or store programming for use by or in connection with an instruction execution system, apparatus, or device.

Software 228 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport readable medium can include, but is not limited to, an electronic, magnetic, optical, electromagnetic, or infrared wired or wireless propagation medium.

Computer system 218 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Computer system 218 can implement any operating system suitable for operating on the network. Software 228 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

### Method for Generating Synthetic Edge Case Training Data

The disclosed method for generating synthetic edge case training data for a computer vision model may comprise three stages: a generation stage, an evaluation stage, and an iterative refinement stage. Each stage can be carefully designed to challenge the robustness of the computer vision model's detection capabilities against edge case images created through AI-driven, prompt-based learning. In the generation stage, generative text-to-image AI may be employed to produce visual scenarios that are not commonly represented in standard datasets. Through carefully crafted prompts generated by an AI language model, the text-to-image AI model can be tasked with creating complex and nuanced images that encompass a variety of edge case scenarios found in real-world settings. In the evaluation stage, the images resulting from the generation stage may be processed by a pre-trained version of the computer vision model. The model's detection output can be evaluated against ground truth data (e.g., annotated versions of the edge case images). Finally, in the iterative refinement stage, performance data characterizing the effectiveness of the computer vision model may be used to systematically refine the initial prompts to generate new sets of prompts containing potential edge cases that are progressively more challenging for the computer vision model. This iterative loop may therefore explore, uncover, and expand the limitations of the object detection model under test. This iterative loop could be driven by rule-based, reinforcement learning-based, or other algorithms.

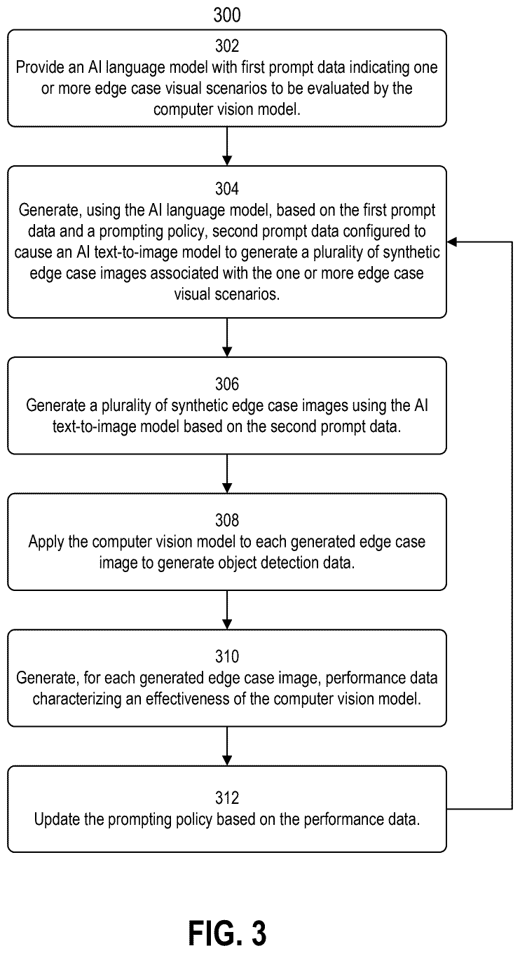

FIG. 3 shows an exemplary method 300 for generating edge case data for training a computer vision model. Method 300 can be executed using a system such as the system for generating edge case data shown in FIG. 1. In various embodiments of method 300, some blocks are, optionally, combined, the order of some blocks is, optionally, changed, and some blocks are, optionally, omitted. In some examples, additional steps can be performed in combination with the blocks of method 300. Accordingly, the operations as illustrated (and described in greater detail below) are exemplary by nature and, as such, should not be viewed as limiting.

Method 300 can be initiated by providing an AI language model (e.g., AI language model 102 shown in FIG. 1) with first prompt data (e.g., first prompt data 108 shown in FIG. 1) indicating one or more edge case visual scenarios (step 302 of method 300). The first prompt data may indicate one or more edge case visual scenarios to be evaluated by the computer vision model. In particular, the first prompt data may describe scenarios in which the computer vision model has a high probability of performing poorly based on, e.g., the historical performance of the computer vision model (or similar computer vision models) and/or the training data upon which the computer vision model has already been trained and/or the scenarios for which the performance of the computer vision model is well understood.

After the AI language model is provided with the first prompt data, an iteration of image data generation and analysis can be performed. The iteration may begin with the generation, by the AI language model, based on the first prompt data and a prompting policy (e.g., prompting policy 106 shown in FIG. 1), of second prompt data for an AI text-to-image model (e.g., AI text-to-image model 104 shown in FIG. 1) (step 304 of method 300). The second prompt data may include text (e.g., natural language) descriptions of the one of more edge case visual scenarios to be evaluated by the computer vision model and may be configured to cause the AI text-to-image model to generate a plurality of edge case images associated with the one or more edge case visual scenarios. Accordingly, once the second prompt data has been generated, the second prompt data may be used by the AI text-to-image model to generate a plurality of edge case images (step 306 of method 300).

Following the generation of the plurality of edge case images, a pre-trained version of the computer vison model may be applied to each synthetic edge case image to output object detection data (e.g., object detection data 114 shown in FIG. 1) (step 308 of method 300). The object detection data can include bounding boxes that identify the locations of objects in the edge case image and/or classification data indicating the type or class of each detected object.

In some embodiments, the object detection data includes confidence scores that quantify the computer vision model's certainty about the presence and/or classification of objects within the edge case image. A confidence score above a predefined confidence score threshold may indicate clear-cut, confident detections where the computer vision model is highly certain of what it sees. Confidence scores below this predefined confidence score threshold may indicate that the computer vision model is less certain of what it sees. The predefined confidence score threshold can be empirically determined. In some embodiments, each confidence score is a percentage between 0% and 100%, were 0% indicates that the computer vision model did not detect the object or is completely uncertain about what it is seeing, and 100% indicates that the computer vision model is completely certain about what it sees. In such cases, the predefined confidence score threshold may be between 55% and 65%, between 65% and 75%, between 75% and 85%, between 85% and 95%, or between 95% and 100%.

For each generated edge case image, performance data (e.g., performance data 116 shown in FIG. 1) characterizing an effectiveness of the computer vision model may be generated (step 310 of method 300). The performance data for a given edge case image can be generated by comparing objects detected by the computer vision model to ground truth data indicating the objects that are actually present in the edge case image. In some embodiments, the performance data includes a reward metric that is configured to incentivize the creation or refinement of prompts that lead to inaccurate detections of certain classes or types of objects by the computer vision model, such as missed detections of safety-critical elements (e.g., a missed pedestrian on the roadway). The evaluation metric can depend on a quantitative measure of the accuracy of the computer vision model's detection of the objects in an image. For example, the reward metric may depend on a performance metric, such as Intersection over Union (IoU) or Mean Average Precision (mAP).

IoU for a given edge case image can be computed by dividing the area of overlap between a bounding box output by the computer vision model and a ground truth bounding box by the area encompassed by the union of the two bounding boxes, as shown in Equation 1:

$$IoU = \frac{\begin{matrix}Area of overlap between \\ predicted ( model output ) and ground truth boxes\end{matrix}}{\begin{matrix}Area of union between \\ predicted ( model output ) and ground truth boxes\end{matrix}} \qquad ( 1 )$$

Area of overlap may be determined by identifying the coordinates where the model's bounding box and the ground truth bounding box intersect. Area of union may be determined by combining the areas covered by both the model's bounding box and the ground truth bounding box and subtracting the area of overlap. The IoU may yield a value ranging between 0 and 1, where a value of 1 indicates perfect overlap and a value of 0 denotes no overlap. For a given edge case image, the performance of the computer vision model may be considered accurate if the IoU value exceeds an IoU threshold, which may be empirically determined. In various embodiments, the IoU threshold is 0.4, 0.5, 0.6, 0.7, 0.8, 0.9, or 0.99. In some embodiments, the IoU threshold is between 0 and 0.4 or between 0.99 and 1.

The mAP can quantitatively measures the spatial and classification accuracy (including consideration of confidence scores) of the computer vision model's bounding box predictions in comparison to the actual objects in the edge case images. The mAP may take into consideration the precision and recall (ratios of true positives to positive predictions and actual positives respectively), as well as IoU, across all classes for a given iteration. The confidence scores obtained from the detections can be used to prioritize and/or rank predictions that will be used to calculate average precision scores for the image.

As noted above, using a quantitative measure of performance accuracy for each edge case image, a reward metric configured to incentivize the generation of text prompts by the AI language model describing visual scenarios that either eluded the computer vision model's identification and/or classification or for which the computer vison model experienced low confidences in previous runs can be computed. Equation 2 defines an example reward function for a computer vision model in an autonomous roadway safety system based on mAP, giving higher rewards to those classifications with low mAP:

$$Reward = \{ \begin{matrix}4 if mAP < 0.3 \\ 2 if 0.3 \leq mAP < 0.6 \\ 1 if 0.6 \leq mAP < 0.9 \\ 0 if mAP \geq 0.9\end{matrix} \qquad ( 2 )$$

In Equation 2, “mAP” is an aggregated precision and recall score from all object detections in a single image, which may reflect the model's overall detection precision for all objects within a given edge case image and capture how closely the model's predictions align with the actual locations of objects. For a computer vision model that is a part of an autonomous roadway safety system, the reward metric can afford additional weight to missed detections of safety-critical elements such as pedestrians on or near the roadway. Therefore, the reward function may allocate a bonus when the model fails to detect a safety-critical element such as a pedestrian. For example, the reward function in Equation 1 could add 3 bonus points to the reward if there was one or more missed pedestrian detections in the frame by the computer vision model in the edge case image (i.e., one or more false positives). The number and types of safety-critical elements can be predetermined by a user and weighted according to their relative criticality.

The prompting policy may include a quality assurance module configured to assess and control overall image quality. This quality assurance module can be built into the reward function or can be a post-processing filter. Image quality can include factors such as realism (in overall style and in the nature of the scene) and image alignment to the input prompt. For example, Contrastive Language-Image Pre-training (CLIP) scores could be used to assess how well the generated image aligns to the text prompt.

If the performance data indicate good performance (e.g., based on a value of a predefined or dynamically determined threshold score) for at least one of the generated edge case images, then it may be determined that said edge case image (and images similar to said edge case image) would not be of significant value in re-training the computer vision model or in training other computer vision models, and hence are given a reward of “0.” For example, in Equation 2, a value of 0.9 for mAP is used to determine the threshold for good detection performance. In such cases, the prompting policy may generate updated second prompt data and updated edge case images. The new edge case images may be of higher complexity than the at least one edge case image for which the computer vision model displayed good performance during the first iteration of image data generation and analysis and may thus be more likely to be of value in training or re-training the computer vision model.

Updating the prompting policy may include modifying one or more parameters of the prompting policy to generate more complex second prompt data for the AI text-to-image model. In some embodiments, updating the prompting policy includes regenerating the prompting policy from scratch or modifying existing contents of prompting policy. In some embodiments, one or more of the edge case images synthesized during the first iteration of image data generation and analysis may be regenerated from scratch. In some embodiments, existing contents and/or existing portions of one or more of the edge case images synthesized during the first iteration of image data generation and analysis may be modified.

The updated prompting policy can be configured such that the updated second prompt data causes the AI text-to-image model to generate a plurality of images having increased level of complexity relative to the at least one image generated during the first iteration for which the computer vision model was highly effective. For example, the prompting policy can be updated such that the updated second prompt data causes the AI text-to-image model to generate images that, compared to an image generated during the first iteration of image data generation and analysis for which the computer vision model was highly effective, show a greater number of objects, show a greater variety of objects, have different lighting, or show a greater number of obstructions that may prevent the computer vision model from identifying objects of importance.

If, on the other hand, the performance data indicate poor performance (e.g., based on a predefined or dynamically determined threshold score) of the computer vision model, then it may be determined that the analyzed edge case images would be of significant value in re-training the computer vision model or training other computer vision models, and the edge case images may therefore be stored in a synthetic training data database such that they may be used to re-train the computer vision model or to train additional computer vision models for improved performance. In some embodiments, if the performance data indicate poor performance of the computer vision model, the iterations of the image data generation and analysis may cease.

In some embodiments, additional iterations of image data generation and analysis may be performed in order to generate more synthetic edge case images that are similar to synthetic edge case images that have already been established to lead to poor performance by the computer vision model. For example, if the performance data indicate that the computer vision model cannot effectively interpret a certain visual scenario, the prompting policy can be updated to cause the AI language model to generate updated second prompt data that contains a larger number of examples of that visual scenario. For example, if an edge case image depicts a city intersection on a rainy day, and the computer vision model fails to identify a pedestrian in the intersection, the performance data may indicate the computer vision model's failure and the prompting policy may be updated to cause the AI language model to generate updated second prompt data that contains additional examples of a city intersection on a rainy day with pedestrians at or near the intersection. In this way, a larger body of training data depicting edge case scenarios that are difficult for the computer vision model (and therefore expected to be valuable in re-training the computer vision model or training other computer vision models) may be quickly and effectively generated.

### Example

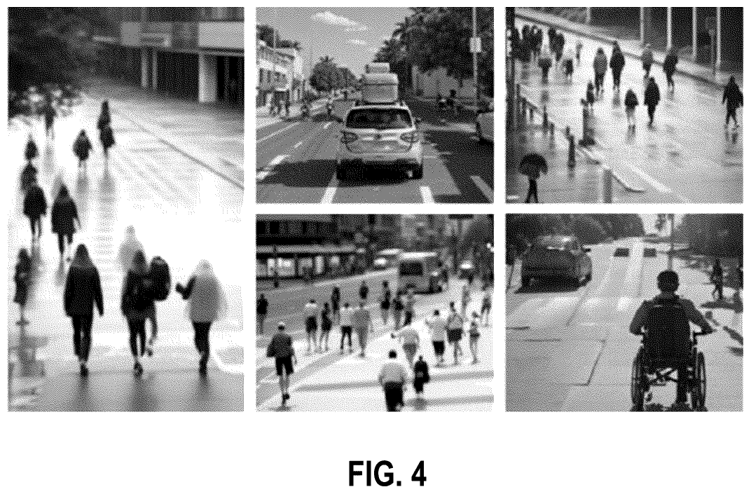

The provided techniques were used to generate edge case training data for YOLOv8, a common implementation at the core of many computer vision applications within autonomous systems. First, in the generation stage, generative AI, specifically Leonardo AI's image generation capabilities, was employed to produce visual scenarios that are not commonly represented in standard datasets (e.g., pedestrian detection in adverse weather conditions—see FIG. 4). Through carefully crafted prompts generated by OpenAI's ChatGPT, a Large Language Model (LLM)-based chatbot, Leonardo AI was tasked with creating complex and nuanced images that encompass a variety of edge case scenarios found in real-world settings. Second, in the evaluation stage, the images resulting from the generation stage were processed by a pre-trained YOLOv8 model. The model's detection output was evaluated against ground truth data annotated manually using a tool called Labelling. The evaluation metric was the Intersection over Union (IoU), which quantitatively measures the accuracy of the model's bounding box predictions in comparison to the actual objects in the images. Third, in the iterative refinement stage, using the IoU scores as feedback, a reinforcement learning algorithm systematically refines the initial prompts to generate new sets of edge cases that are progressively more challenging for YOLOv8.

The following is an example prompt refined by ChatGPT describing an edge case visual scenario: “Car driving late at night in the snow has trouble seeing pedestrians.” This prompt was provided as input to Leonardo AI. Leonardo AI synthesized an edge case image corresponding to the prompt. This synthetic edge case image was input into YOLOv8, which ran object detection on the generated synthetic image, returned bounding boxes, and output detected classes and confidence scores for each detected object.

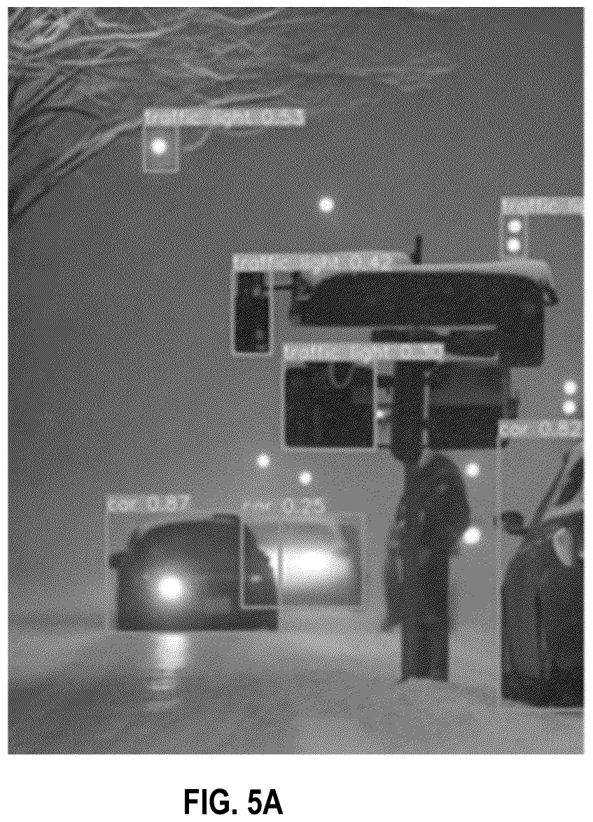

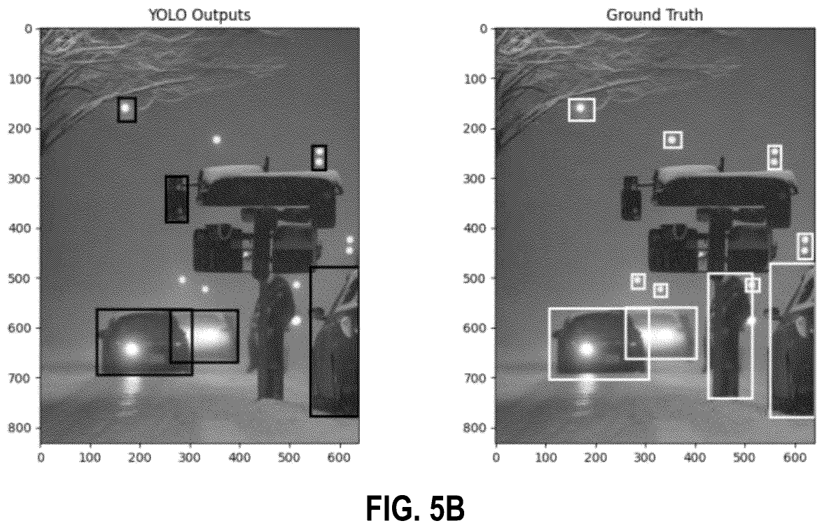

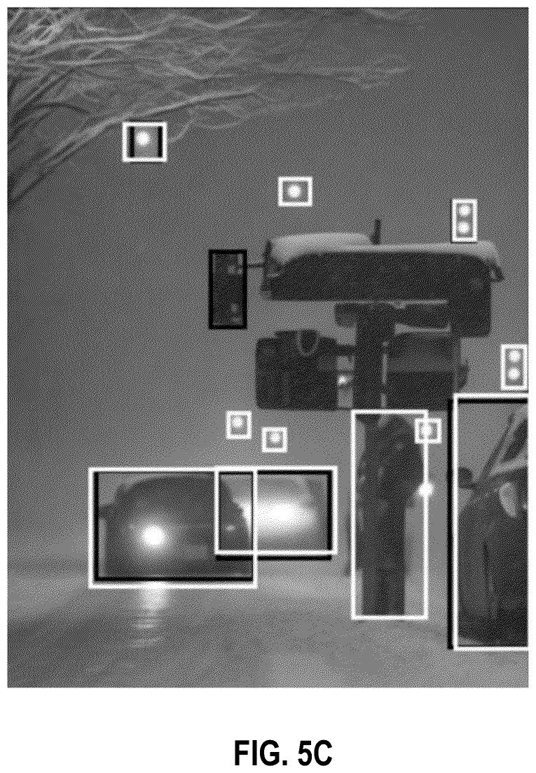

FIG. 5A shows the object detection output from YOLOv8. As shown, YOLOv8 did not detect the pedestrian behind the pole. YOLOv8's output was compared to the ground truth to assess the performance of both YOLOv8 and the image generator in its ability to create an edge case image that tricks YOLOv8. Using Labelling for ground truth annotation, validation of the generated images was performed. A human researcher used Labelling to manually draw bounding boxes, add labels, and extract information from the images that align with YOLOv8 documentation.

The discrepancy between the YOLOv8 detections and the ground truth is shown in FIG. 5B, where the YOLOv8 output and the ground truth image are plotted with the same scale, and the coordinates of the bounding boxes are compared. In FIG. 5C, black bounding boxes denote YOLOv8-derived detections, while white bounding boxes represent ground truth. The left image (YOLOv8 output) fails to identify a pedestrian obscured by a street pole and a few red traffic lights. The right image shows the ground truth, which includes the missed pedestrian and traffic lights. This image demonstrates an example where YOLOv8 faces challenges with partial occlusions in complex environments. The reward mechanism uses the ground truth image and the YOLOv8 detected image to calculate the IoU and the overall reward for that image. An overlay of the ground truth and YOLOv8 bounding boxes is shown in FIG. 5C.

The performance data obtained from comparing the YOLOv8 output to the ground truth indicated the need to generate similar images that challenge YOLOv8. The prompting policy used to generate the prompts for Leonardo AI using ChatGPT was updated based on the performance data. The policy updates enabled ChatGPT to create similar, possibly more complex prompts to be fed to Leonardo AI. Table 3 shows improvements to an example prompt refined by ChatGPT as the prompting policy was updated.

TABLE 3
Example ChatGPT prompt improvement

| Version | A car driving late at night in the snow has trouble |
|---|---|
| 1 | seeing pedestrians with more traffic lights in the |
| | background. |
| Version | A car driving late at night in the snow has trouble |
| 2 | seeing pedestrians focusing on a traffic light that |
| | is partially obscured. |
| Version | A car driving late at night in the snow has trouble |
| 3 | seeing pedestrians with more persons in the background. |
| Version | A car driving late at night in the snow has trouble |
| 4 | seeing pedestrians with low light conditions. |
| Version | A car driving late at night in the snow has trouble |
| 5 | seeing pedestrians with a person in low light conditions. |

The foregoing description, for the purpose of explanation, has been described with reference to specific embodiments and/or examples. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

As used herein, the singular forms “a”, “an”, and “the” include the plural reference unless the context clearly dictates otherwise. Reference to “about” a value or parameter or “approximately” a value or parameter herein includes (and describes) variations that are directed to that value or parameter per se. For example, description referring to “about X” includes description of “X”. It is understood that aspects and variations of the invention described herein include “consisting of” and/or “consisting essentially of” aspects and variations.

When a range of values or values is provided, it is to be understood that each intervening value between the upper and lower limit of that range, and any other stated or intervening value in that stated range, is encompassed within the scope of the present disclosure. Where the stated range includes upper or lower limits, ranges excluding either of those included limits are also included in the present disclosure.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

Any of the systems, methods, techniques, and/or features disclosed herein may be combined, in whole or in part, with any other systems, methods, techniques, and/or features disclosed herein.

1. A method for generating training data for a computer vision model, the method comprising:
providing an AI language model with first prompt data indicating one or more visual scenarios to be evaluated by the computer vision model;
performing an iteration of image data generation and analysis, comprising:
generating, using the AI language model, based on the first prompt data and a prompting policy, second prompt data for an AI text-to-image model, wherein the second prompt data is configured to cause the AI text-to-image model to generate a plurality of images associated with the one or more visual scenarios;
generating, using the AI text-to-image model, the plurality of images using the second prompt data;
applying the computer vision model to each image of the plurality of generated synthetic images to generate, for each of the images, respective object detection data; and
generating, for each image of the generated images, performance data characterizing an effectiveness of the computer vision model;
updating the prompting policy based on the performance data, and
performing a second iteration of image data generation and analysis, wherein performing the second iteration comprises generating updated second prompt data based on the updated prompting policy.

2. The method of claim 1, further comprising determining that the second iteration of image data generation and analysis should be performed.

3. The method of claim 2, wherein determining that the second iteration of image data generation and analysis should be performed comprises determining that the performance data indicate high effectiveness of the computer vision model for at least one image of the plurality of generated images.

4. The method of claim 3, wherein updating the prompting policy comprises configuring the prompting policy such that the updated second prompt data generated by the AI language model causes the AI text-to-image model to generate an updated plurality of images having increased level of complexity relative to the at least one image of plurality of images generated by the AI text-to-image model during the first iteration of image data generation and analysis for which the computer vision model was highly effective.

5. The method of claim 2, wherein determining that the second iteration of image data generation and analysis should be performed comprises determining that the performance data indicate low effectiveness of the computer vision model for at least one image of the plurality of synthesized images.

6. The method of claim 5, wherein updating the prompting policy comprises configuring the prompting policy such that the updated second prompt data generated by the AI language model causes the AI text-to-image model to synthesize an updated plurality of images having a similar level of complexity to the at least one image of the plurality of images synthesized by the AI text-to-image model during the second iteration of image data generation and analysis for which the computer vision model had low effectiveness.

7. The method of claim 1, further comprising determining that a third iteration of image data generation and analysis should not be performed.

8. The method of claim 7, wherein determining that a third iteration of image data generation and analysis should not be performed comprises determining that the performance data indicate low effectiveness of the computer vision model for the plurality of generated images.

9. The method of claim 8, further comprising storing the plurality of generated images for which the performance data indicated poor performance by the computer vision model in a database of training data for the computer vision model.

10. The method of claim 9, further comprising re-training the computer vision model based on the plurality of generated images stored in the database of training data.

11. The method of claim 1, wherein the AI language model is a large language model.

12. The method of claim 1, wherein the object detection data for one or more images of the plurality of generated images comprises one or more respective bounding boxes indicating one or more respective locations in the respective image of objects detected by the computer vision model.

13. The method of claim 1, wherein the object detection data for one or more images of the plurality of generated images comprises classification data indicating one or more object types detected in the respective image by the computer vision model.

14. The method of claim 1, wherein the object detection data for one or more images of the plurality of generated images comprises confidence score data indicating one or more confidence values associated with a respective object detected in the respective image by the computer vision model.

15. The method of claim 1, wherein generating the performance data for an image of the plurality of generated images comprises comparing object detection data for the image to corresponding ground truth data indicating objects that are actually present in the image.

16. The method of claim 1, wherein generating the performance data for an image of the plurality of generated images comprises computing a reward metric for the image, wherein the reward metric is configured to quantify a performance level of the computer vision model.

17. The method of claim 16, wherein a magnitude of the reward metric is greater when the performance of the computer vision model for the image is lower.

18. The method of claim 1, wherein generating the performance data for an image of the plurality of images comprises determining whether the computer vision model accurately identified one or more critical objects in the image.

19. The method of claim 1, wherein the prompting policy is updated using reinforcement learning.

20. The method of claim 1, wherein the computer vision model is configured to be used in an autonomous roadway safety system.

21. A system for generating synthetic image training data for a computer vision model, the system comprising one or more processors configured to:
provide an AI language model with first prompt data indicating one or more visual scenarios to be evaluated by the computer vision model;
perform an iteration of image data generation and analysis, comprising:
generate, using the AI language model, based on the first prompt data and a prompting policy, second prompt data for an AI text-to-image model, wherein the second prompt data is configured to cause the AI text-to-image model to generate a plurality of images associated with the one or more visual scenarios;
generate, using the AI text-to-image model, the plurality of images using the second prompt data;
apply the computer vision model to each image of the plurality of generated images to generate, for each of the images, respective object detection data; and
generate, for each image of the synthesized images, performance data characterizing effectiveness of the computer vision model;
update the prompting policy based on the performance data, and
perform a second iteration of image data generation and analysis, wherein performing the second iteration comprises generating updated second prompt data based on the updated prompting policy.

22. A non-transitory computer readable storage medium storing instructions for generating training data for a computer vision model that, when executed by one or more processors of a computer system, cause the system to:
provide an AI language model with first prompt data indicating one or more visual scenarios to be evaluated by the computer vision model;
perform an iteration of image data generation and analysis, comprising:
generate, using the AI language model, based on the first prompt data and a prompting policy, second prompt data for an AI text-to-image model, wherein the second prompt data is configured to cause the AI text-to-image model to generate a plurality of images associated with the one or more visual scenarios;
generate, using the AI text-to-image model, the plurality of images using the second prompt data;
apply the computer vision model to each image of the plurality of generated images to generate, for each of the images, respective object detection data; and
generate, for each image of the generated images, performance data characterizing an effectiveness of the computer vision model;
update the prompting policy based on the performance data, and
perform a second iteration of image data generation and analysis, wherein performing the second iteration comprises generating updated second prompt data based on the updated prompting policy.
